(19) United States
(12) Patent Application Publication
(10) Pub. No.: US 2009/0055849 A1
(43) Pub. Date: Feb. 26, 2009

(54) Angle sensor with multi-turn encoding

(76) Inventors: Laurent Geyl, Strasbourg (FR); Johann Michel, Mutzig (FR); Laurent Tupinier, Reichstett (FR)

Correspondence Address: DELPHI TECHNOLOGIES, INC., M/C 480-410-202, PO BOX 5052, TROY, MI, 48007, US

(21) Appl. No.: 12/229,298

(22) Filed: Aug. 21, 2008

(30) Foreign Application Priority Data
Aug. 23, 2007 (EP) 07360038.9

(51) Int. Cl. G11B 7/00

(52) U.S. Cl. 720/660

(57) ABSTRACT

An angle sensor includes a rotary disc provided with an annular surface divided into cells for encoding the angular position of the disc, the said cells transforming an incident light beam into an optical light signal conveying a code of the said angular position, the said signal being conducted by a light guide to a fixed photodetector connected to means for processing of the said code.

The light guide is moveable in rotation about an axis parallel with the axis of rotation of the disc, an arm attached to the said guide, driven in a radial direction by the rotating disc, displacing the light guide relatively to the photodetector.

### TECHNICAL FIELD

The present invention relates to an angle sensor including a rotary disc fixed to a rotating shaft supporting angular encoding means.

### BACKGROUND OF THE INVENTION

One possible application, which acts as a guide-line in the present description, is the steering column of a motor vehicle. In such an application, in addition to encoding the position of the disc over one turn, it is necessary to know the absolute position of the steering-wheel over a plurality of turns (a steering column has to turn through approximately five turns). Now, the majority of current angle sensors only provide absolute encoding of the angular position over one turn, and it therefore remains to encode which is the current turn.

Incremental counting of the turns is not sufficient, as the precise position of the steering-wheel must be precisely identified even at starting.

A number of currently used solutions are based on magnetic technologies, for example Hall effect sensors associated with geared mechanical solutions. The toothed wheels are then eccentric relative to the steering column, and care must be taken to design as compact as possible a solution, as the volume available beneath the steering-wheel is generally small.

There also exist optical solutions based on shade technology, like for example the solutions disclosed in the document DE-198 55 064. These describe configurations in which the light source is arranged radially on one side of the rotary disc, a photodetector being arranged in parallel on the other side of the disc. A slide moveable in a radial direction relatively to the disc blocks or filters the passage of the light beam from the light source in order to perform encoding of the turn. An element for blocking or filtration of the light beam, directly integrated in the rotary disc, also permits encoding of the angular position over one turn. The same photodetector is therefore used to process the displacement of two light signals respectively encoding the turn and the angular position.

In two of the three solutions shown, the system permitting radial displacement of the slide is not explained. In the third case, it involves a rider guided in rotation by a spiral relief track, and held in radial translation by a very narrow rectilinear detection device, which is not compatible with conventional photodetectors available commercially. The proposed solutions therefore appear theoretical.

### SUMMARY OF THE INVENTION

The angle sensor of the present invention, also including a rotary disc, is provided with an annular surface divided into cells for encoding the angular position of the disc, the said cells transforming an incident light beam into an optical light signal conveying a code of the said angular position, the said signal then being conducted by a light guide to a fixed photodetector connected to means for processing the said code.

In accordance with an essential characteristic of the invention, the light guide is moveable in rotation about an axis parallel with the axis of rotation of the disc, an arm attached to the said guide, driven in a radial direction by the rotating disc, displacing the light guide relatively to the photodetector.

In other words, the signal conveying the optical code corresponding to the angular position of the rotary disc is also displaced relative to the photodetector. The positioning of the signal relatively to the photodetector is used to determine the current turn. Thus, contrarily to the solutions of the prior art, the photodetector does not detect two types of light signal corresponding respectively to encoding of the angular position and of the turn, but only one light signal, the position of which relative to the detector changes depending on the turn.

In accordance with one possibility, the disc can include a groove spiralled over n turns, guiding a finger fitted to the free end of the arm fixed to the light guide. In the example of the steering column, the groove extends in a spiral round approximately five turns.

Taking into account that the light guide has only a degree of freedom in rotation, the finger guided by the spiral groove is displaced substantially radially relative to the disc, and causes the said light guide to pivot.

Preferably, the axis of rotation of the guide is positioned in the vicinity of the edge of the disc, and contiguous with the input of the light guide.

More preferably, the arm is also attached to the light guide at its input, but on the side opposite to the axis of rotation. This arm in fact acts as an actuating lever communicating its movement to the light guide.

The latter can, for example, have a rectilinear portion orientated substantially tangentially to the disc.

More precisely, the light guide can be formed of two light deflectors, input and output respectively, connected by a rectilinear portion giving the light signal an inverted U-shaped path.

The incident light beam is transformed into an optical signal conveying a code of the angular position, which is then conducted to the fixed photodetector, in this case positioned outside the disc substantially at the same level as the disc.

Moreover, preferably, the pivot of the rotation of the light guide and the photodetector are positioned on a same plate.

The prior art shows configurations in which the components are placed on either side of the disc, increasing the amount of space occupied in the volume under the steering-wheel necessary to installation of a steering column angle sensor. In the invention, the pivot of the rotation of the light guide and the electronic component forming the photodetector are arranged practically at the same level, permitting substantial reduction of the thickness of the angle sensing unit.

Preferably, in accordance with the invention, the encoding cells include computer-generated holograms, diffracting the light beam formed of a laser beam into a digital optical code.

Cells with computer-generated holograms are easy to manufacture by injection or pressing on a plastics disc in accordance with a well established industrial process. When the light beam illuminates a cell provided with a computer-generated hologram, it generates a unique diffraction figure formed of illuminated or dark spots, forming a digital optical code. This binary code indicates a precise angular position of the rotary disc.

In accordance with one possibility, the photodetector consists of a row of photodetection cells. In practice, this is a conventional electronic component with legs which can be soldered onto a printed circuit.

Under this hypothesis, the computer-generated holograms forming the encoding cells placed on the rotary discs are so provided that the diffracted signal constitutes a binary code formed of light or dark spots which are aligned. The light guide then conducts the row of spots forming this code to the photodetector in such a way that the axis of the photodetection cells and that of the row of spots are substantially parallel.

The processing means, in accordance with the invention, then effect encoding of the turn by determination of the positioning of the optical code conveyed by the optical signal relatively to the photodetector.

In other words, the encoding of the turn depends on the position of the excited cells within the row of cells forming the photodetector.

It is then necessary to provide a photodetector formed of a sufficient number of photodetection cells to permit reading of the displacement of the digital codes obtained by diffraction along the row of photodetection cells, and to match the displacement of the mechanical system—in this case the rotary light guide—to the length of the photodetector.

### BRIEF DESCRIPTION OF THE INVENTION

The invention will now be described in more detail, with reference to the figures, in which:

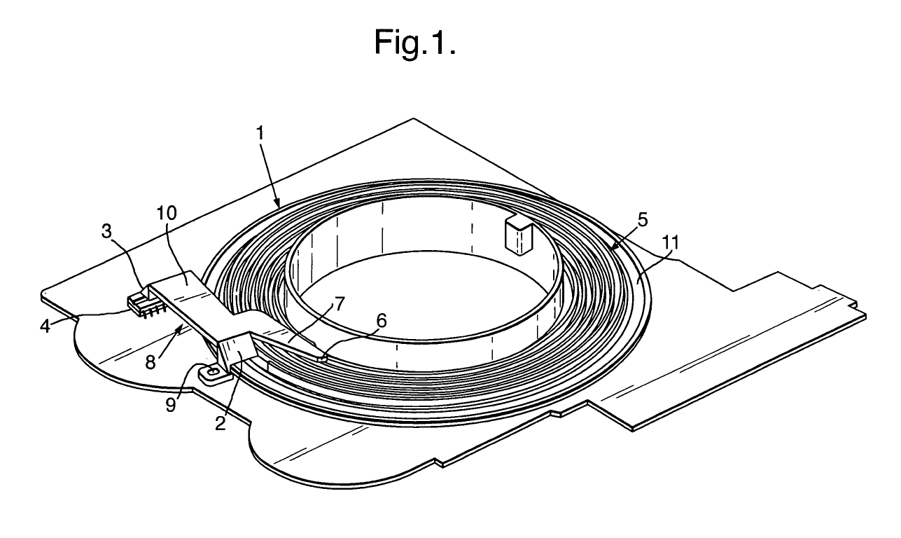

FIG. 1 shows, in partial perspective, the configuration adopted for the angle sensor of the invention; and

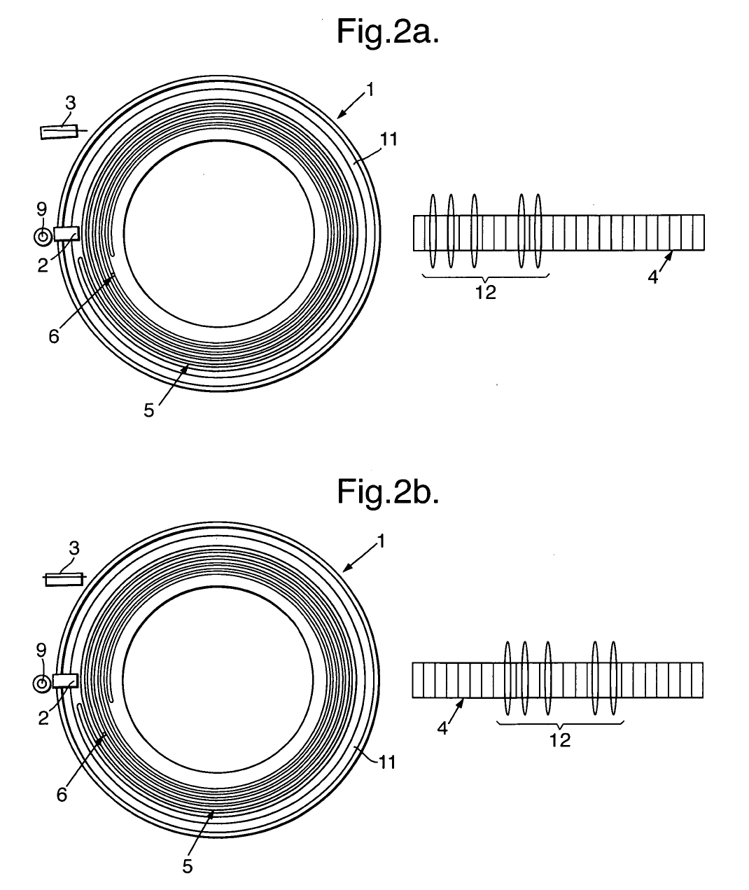

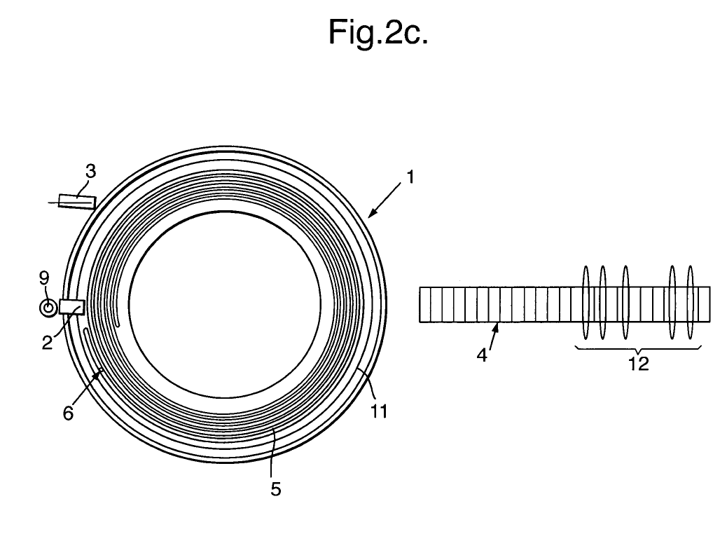

FIGS. 2a to 2c diagrammatically show the operation of the device, showing the displacement of the digital optical code relative to the photodetector as a function of the turn through which the angle sensor is passing.

### DESCRIPTION OF THE PREFERRED EMBODIMENT

With reference to FIG. 1, a rotary disc (1), attached in the example of application employed to a steering column (not shown), includes on its upper surface spiral grooves (5) guiding a finger (6) arranged at the end of an arm (7) attached to the end of a light guide (8) free to rotate about a pivot (9). This light guide (8) is formed of prisms (2, 3), input (2) and output (3) respectively, joined by a rectilinear portion (10). A peripheral annular surface (11) of the rotary disc (1) is provided with cells for encoding the angular position of the disc.

These cells, in this case including computer-generated holograms, diffract an incident laser beam. The diffracted light signal is then conducted, by the light guide (8), to a photodetector component (4) including photodetection cells aligned in a row. The diffracted signal (12), composed of illuminated and dark spots, is conveyed by the light guide (8) to the photodetector (4). The holograms are so calculated that the diffracted signal includes spots in lines, generated in a substantially radial direction relative to the rotary disc (1), so that the row of spots recreated by the output prism (3) of the light guide (8) is parallel with the row of photodetection cells of the component (4).

When the steering column rotates, driving the rotary disc (1), the finger (6) is displaced in a substantially radial direction causing pivoting, by means of the arm (7), of the light guide (8) about the pivot (9). This is shown in FIGS. 2a to 2c. Thus, with reference to FIG. 2a, the finger (6) is in the first turn of rotation, the output prism (3) of the photodetector is positioned towards one of the ends of the photodetector component (4), and the digital light code obtained after diffraction is guided to one of the ends of the line of photodetection cells.

In FIG. 2b, the finger (6) is approximately in the middle, i.e. in the third turn since it is considered that a steering column must effect approximately 5 turns. In this case, the diffracted light conveying the binary code encoding the angular position of the disc (1) is substantially in the middle of the photodetector (4).

Lastly, FIG. 2c shows location in turn (5), and the binary code is then offset towards the other end of the line of photodetection cells.

Encoding of the turn is therefore simply effected by recognition by the processing system of the zone in which the diffractive code is situated. Preliminary calibration permits exact knowledge, as a function of the illuminated photodetection cells, of the current turn. It is then possible to simply encode, in addition to the angular position by the diffraction code obtained, the turn by the position of this code on the line of photodetection cells.

1. An angle sensor comprising a rotary disc defining an annular surface divided into cells for encoding the angular position of the disc, the cells transforming an incident light beam into an optical light signal conveying a code of the said angular position, wherein the signal is conducted by a light guide to a fixed photodetector connected to means for processing the code, wherein the light guide is moveable in rotation about an axis parallel with the axis of rotation of the disc, an arm attached to said guide, driven in a radial direction by the rotating disc, displacing the light guide relatively to the photodetector.

2. The angle sensor of claim 1, wherein the disc includes a groove spiralled around n turns, guiding a finger with which the end of the arm attached to the light guide is equipped.

3. The angle sensor of claim 1, wherein the axis of rotation of the light guide is positioned in the vicinity of the edge of the disc, and contiguous with the input of the light guide.

4. The angle sensor of claim 3, wherein the arm is attached to the light guide at its input, on the opposite side to the axis of rotation.

5. The angle sensor of claim 1, wherein the light guide presents a rectilinear portion orientated substantially tangentially to the disc.

6. The angle sensor of claim 1, wherein the light guide is formed of two light deflectors, input and output respectively, joined by a rectilinear portion giving the light signal an inverted U-shaped path.

7. The angle sensor of claim 1, wherein the pivot of the rotation of the light guide and the photodetector are positioned on a same plate.

8. The angle sensor of claim 1, wherein the encoding cells include computer-generated holograms, diffracting the light beam formed of a laser beam into a digital optical code.

9. The angle sensor of claim 1, wherein the photodetector comprises of a row of photodetection cells.

10. The angle sensor of claim 9, wherein encoding of the turn depends on the position of the excited cells within the row of cells forming the photodetector.

11. The angle sensor of claim 1, wherein the processing means effect encoding of the turn by determination of the optical code conveyed by the optical signal relatively to the photodetector.

12. An angle sensor comprising:
a disc carried for rotation about an axis, said disc defining an annular surface divided into discrete cells for encoding the angular position of said disc, wherein said cells are operative to transform an incident light beam into an optical light signal as a function of said angular position;
a light guide operative to conduct said signal, which is radially displacable in response to rotation of said disc; and
a relatively fixed photodetector disposed for controlled registration with said light guide, operative to receive said signal and generate an output signal as a function thereof.
